(19) United States
(12) Patent Application Publication
(10) Pub. No.: US 2011/0119070 A1
(43) Pub. Date: May 19, 2011

(54) Accountability system

(76) Inventor: Debra Kaye Borkowski, Tampa, FL (US)

(21) Appl. No.: 12/927,573

(22) Filed: Nov. 18, 2010

Related U.S. Application Data
(60) Provisional application No. 61/281,525, filed on Nov. 19, 2009.

(51) Int. Cl. G06Q 99/00

(52) U.S. Cl. 705/1.1

(57) ABSTRACT

A method and system to provide a process or program to evaluate a participant or candidate elected to public office on a plurality of elements or campaign promises and to report evaluations on each of the elements or campaign promises and overall evaluation by a plurality of members or voters to hold elected officials accountable for campaign promises wherein during an initial or campaign phase the participant or candidate for elected office selects the plurality of elements or campaign promises the participant or candidate for elected office commits to be evaluated on, each of the elements or campaign promises is then transmitted to an accountability/survey platform and stored in a data base where members or voters can observe the elements or promises displayed either at the accountability/survey site or the candidate for elected office site and wherein during a subsequent elected phase a member or voter can evaluate the performance of the participant or elected official with respect to the plurality of elements or campaign promises and assign one of a plurality of evaluation levels or grades to each of the elements or campaign promises transmitted to the accountability/survey platform site and entered into the data base to be tabulated and reported to the participant or elected official and members or voters.

### CROSS-REFERENCE

The application claims priority from pending provisional application Ser. No. 61/281,525 filed Nov. 19, 2009.

### BACKGROUND OF THE INVENTION

1. Field of the Invention

A method and system to provide a process or program for evaluating each of the plurality of elements selected by a participant or candidate elected to public office in one of at least two levels of evaluation and reporting the level of evaluation for each selected element to the participant or elected official.

2. Description of the Prior Art

Historically, candidates have made campaign promises or commitments that are, post election, quickly forgotten. As an unfortunate consequence, elected officials are seldom held fully accountable. As a result, voters expectations are rarely fulfilled.

Numerous examples of surveys to record and report customer or client evaluation and satisfaction for various goods and services are found in the prior art.

Unfortunately, there is a dearth of surveys or the like to systematically record and evaluate the commitments or promises offered by political candidates seeking public office.

The instant invention comprises a method and system for recording candidate promises and grading or qualitatively evaluating an elected official's performance by comparing actual of perceived performance with campaign promises.

### SUMMARY OF THE INVENTION

The present invention relates to a system and method for documenting the campaign promises of a candidate for elected office and a process for voters to evaluate the measure of fulfillment of the campaign promises if the candidate is elected.

Initially, the candidate for elected office establishes a candidate account with an accountability/survey platform that, in turn, records the candidate's information and campaign promises in a data base. Members or voters can then access over an electronic network the records of individual candidates including the campaign promises maintained in the data base. An on-line evaluation system including a grading format corresponding to any candidate elected to public office is provided on the accountability/survey platform. The grading format includes a plurality of grading or evaluation levels corresponding to each campaign promise to allow individual members or voters to evaluate the candidate's performance with respect to each campaign promise.

Specifically, a personalized accountability data base including the candidate's name, image, office sought and campaign promises is created on-line at the accountability/survey platform. If the candidate is elected, the members or voters are able to interact with the accountability/survey platform. Members or voters can log on to the accountability/survey platform and locate or navigate to the selected elected official's information and view the winning candidate's campaign promises. Members or voters can then evaluate the elected official's performance with respect to each campaign promise and choose one of a plurality of evaluation or grade levels that are recorded in the elected official's data base at the accountability/survey platform.

Periodically, the evaluation is dated, sorted and formatted for each elected official. This data is then forwarded to the elected official. The report lists each campaign promise and a corresponding grade from collected data indicating how members or voters grade the elected official's performance with respect to individual campaign promises as well as an overall performance evaluation.

The resulting data can also be tabulated and formatted for release to media outlets. The data can be made available to elected officials in a raw data format so that the data can reviewed and tabulated in various forms or formats such as demographics, zip codes, voting precincts and the like.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

Figure is a block diagram of the accountability system of the present invention depicting the candidate's site, voter's site and accountability/survey site within a network environment.

FIGS. 2A and 2B depict a format for a candidate's personal data or information and campaign promises in either hardcopy or electronic form.

FIG. 3 depicts a format for grading or evaluating an individual elected official's performance with respect to campaign promises.

Similar reference characters refer to similar parts throughout the several views of the drawings.

### DETAILED DESCRIPTION OF THE PREFERRED EMBODIMENT

The present invention relates to a method and system to evaluate or grade an elected official in fulfilling promises made during his or her campaign for office. In particular, the system comprises an accountability/survey platform site coupled to at least one participant or candidate for elected office site and a plurality of member or voter sites coupled together over a network capable of transmitting, receiving, storing, and displaying data including discrete participant or candidate information such as name, office sought, and campaign promises corresponding with individual candidates, and member or voter evaluations of each campaign promise for successful candidates.

FIG. 1 shows a block diagram of the system adapted and configured to facilitate transfer of information or data relating to individual candidates for elected office, successful candidates, and voter evaluation of individual elected officials with respect to campaign promises over a network 10. The system includes at least one participant or candidate for elected office site 12, a plurality of member or voter sites each designated as 14, and an accountability/survey platform site 16 in communication over the network 10.

The network 10 may comprise a single network or a combination of multiple networks. For example, in various embodiments, the network 10 may include the Internet and/or one or more intranet, landline networks, wireless networks, and/or other appropriate types of communication networks. In another example, the network 10 may comprise a wireless telecommunications network such as a cellular phone network adapted to communicate with other communication networks such as the Internet. In various embodiments, the participant or candidate for elected office's site 12, member or voter site 14, and accountability/survey site 16 may be associated with a particular link such as a URL (Uniform Resource Locator) to an IP (Internet Protocol) address.

Each site 12, 14, and 16 may include a computing system in various embodiments, implemented using any appropriate combination of hardware and/or software configured for wired and/or wireless communication over the network 10. In one example, such a computing system may be implemented as a wireless telephone (cellular phone), a personal digital assistant (PDA), a notebook computer, and/or various other generally known types of wired and/or wireless computing devices.

The computer systems may include a processing unit (CPU), a graphics processing unit (GPU), a memory, a video display unit (liquid crystal display (LCD) or a cathode ray tube (CRT), an alphanumeric input device (keyboard), a user interface (UI), navigation device (mouse), a disk drive unit, a signal generation device (speaker), and a network interface device including signal transmission and receiving capability.

As described hereinafter, the accountability system and method for evaluating elected officials with respect to campaign promises is operable in two (2) modes; i.e., hard copy mode or electronic mode, and two (2) stages; i.e., static stage or interactive stage.

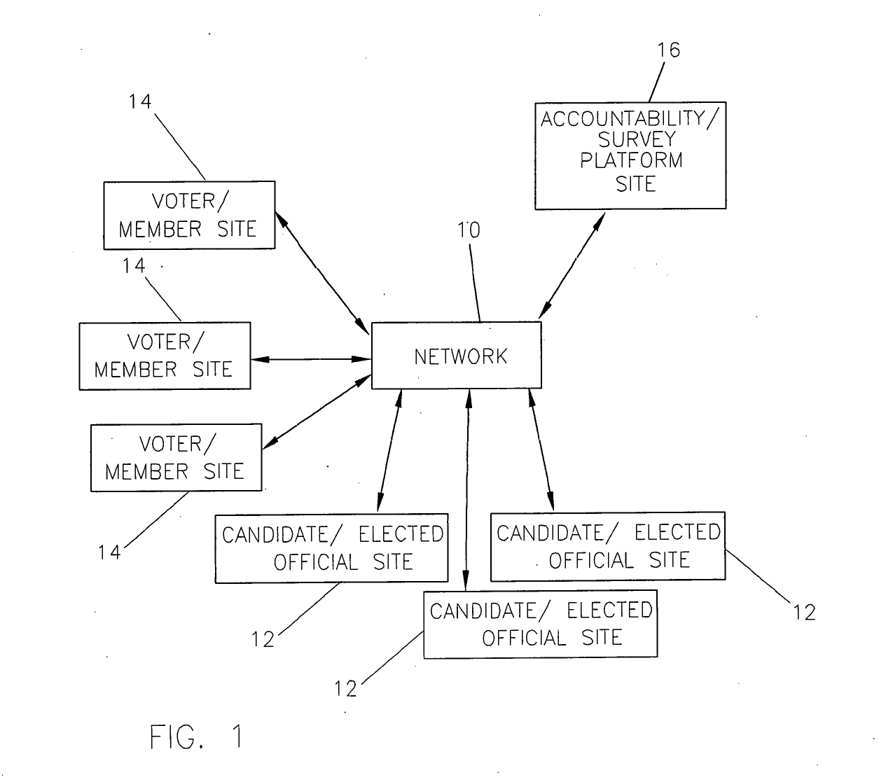

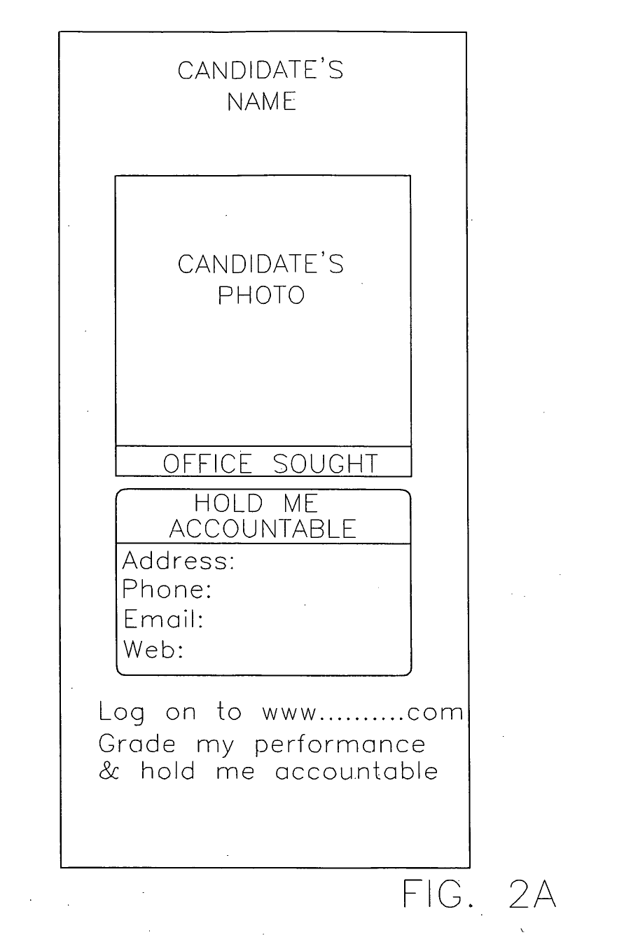

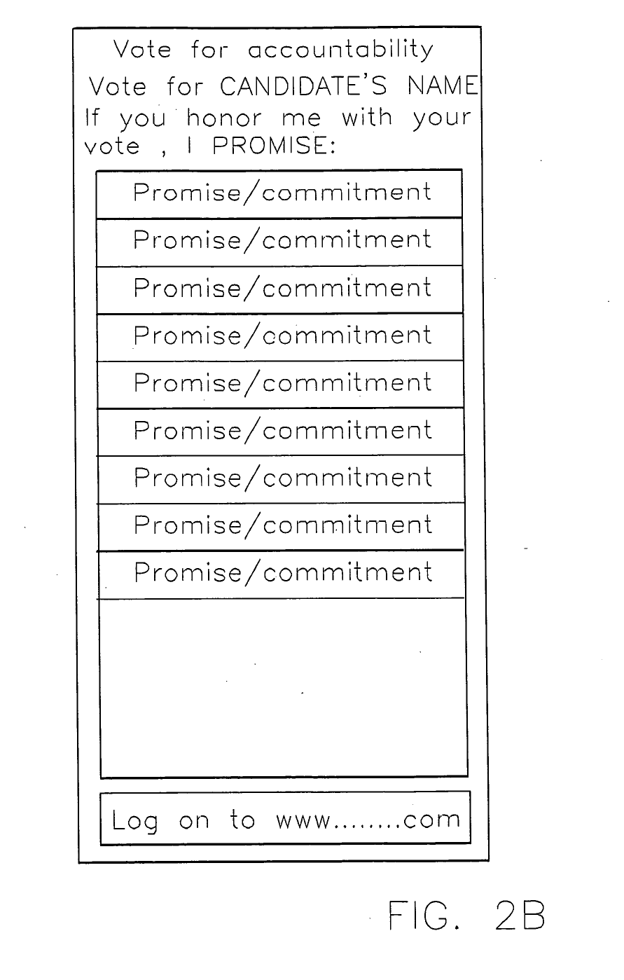

In either mode, personalized accountability data including the candidate's name, image, office sought and campaign promises is created as depicted in FIGS. 2A and 2B.

In the hard copy mode, the data or information is simply printed on a palm card for hand-to-hand distribution.

The candidate for elected office can establish an on-line account in the electronic mode with an accountability/survey platform that, in turn, records the candidate's information and campaign promises in a data base.

The candidate for elected office purchases an e-accountability card viewable only on the survey platform by constituents and visitors. The candidate for elected office is provided a link for the member or voter site 14 that links directly to the candidate's individual e-accountability card on the accountability/survey platform site 16 whenever a member or voter clicks on the candidate's site to activate the link.

The e-accountability card is static at this stage and consists of a page with the same information printed front side of the campaign palm card with campaign promises information as depicted in FIGS. 2A and 2B.

If the candidate purchases an e-accountability card, the candidate's image and link to this campaign website is featured on the survey platform in a section that lists candidates. The candidate is provided with a link that may be placed on the candidate's campaign website homepage that identifies them as using this product. When a visitor to the candidate's campaign website clicks on the link, the visitor will be directed to the candidate's e-accountability card.

Data capture begins once the e-accountability card becomes interactive. First report card of representative's performance is sent to the representative at the end of the first quarter. The system is reset for new data capture for the next quarter.

If the candidate is elected, the members or voters are able to interact with the accountability/survey platform site 16. Members or voters can log on to the accountability/survey platform site 16 and locate or navigate to the selected elected official's information and view the winning candidate's campaign promises. Members or voters can then evaluate the elected official's performance with respect to each campaign promise and choose one of a plurality of evaluation or grade levels that are recorded in the elected official's data base at the accountability/survey platform site 16. It should be noted that a member or voter may only evaluate or grade an elected official for whom the member or voter is eligible to vote.

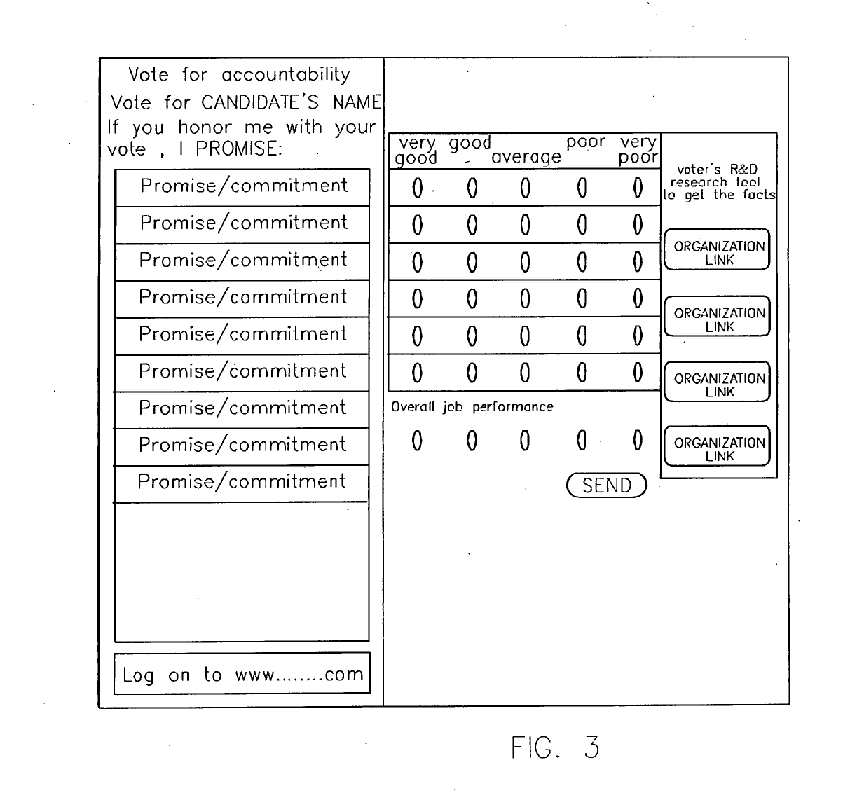

While grading or evaluating an elected official, a member or voter may link to research resources that relate to the subject matter of the elected official's campaign promises as depicted in FIG. 3.

Members can log in and participate over the network 10 in as many grading sessions as designated. However, only the most recent grading session will be tabulated in the final data.

Periodically, the evaluation is dated, sorted and formatted for each elected official. This data is then forwarded to the elected official. The report lists each campaign promise and a corresponding grade from collected data indicating how members or voters grade the elected official's performance with respect to individual campaign promises as well as an overall performance evaluation.

The resulting data can also be tabulated and formatted for release to media outlets. The data can be made available to elected officials in a raw data format so that the data can be reviewed and tabulated in various forms or formats such as demographics, zip codes, voting precincts and the like.

Interactive media can be attached to each promise so that the elected official can address the members or voters directly relating to particular campaign promises without media slant or bias. Such a format will allow the elected official to directly address members or voters.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A method to evaluate a participant on a plurality of elements selected by the participant and to report evaluations on each of said individual elements and overall participant evaluation by a plurality of members wherein the participant selects said plurality of elements to be evaluated, each of said selected elements are stored in a data base, members then evaluate the performance of the participant and assign one of a plurality of evaluation levels or grades to each of said selected elements, said assigned evaluation level or grade for each said selected element into a data base, tabulating said assigned evaluation levels or grades for each selected element and reporting the tabulated results to the participant.

2. A system to provide a process or program to evaluate a candidate elected to public office on a plurality of campaign promises and to report evaluations on each of the campaign promises and overall evaluation by a plurality of voters to hold elected officials accountable for campaign promises wherein during an initial or campaign phase the candidate for elected office selects said plurality of campaign promises candidate for elected office commits to be evaluated on, each of said campaign promises is then transmitted to an accountability/survey site and stored in a data base where voters can observe said promises displayed either at said accountability/survey site or said candidate for elected office site and wherein during a subsequent elected phase a voter can evaluate the performance of the elected official with respect to said plurality of campaign promises and assign one of a plurality of evaluation levels or grades to each of said campaign promises transmitted to said accountability/survey platform site and entered into said data base to be tabulated and reported to the elected official and voters.
